(19) United States
(12) Patent Application Publication
(10) Pub. No.: US 2026/0146482 A1
(43) Pub. Date: May 28, 2026

(54) VEHICLE DOOR LATCH, ASSOCIATED VEHICLE DOOR AND ASSOCIATED METHOD

(71) Applicant: Minebea AccessSolutions France, Alfortville (FR)

(72) Inventors: François DEBROUCKE, Alfortville (FR); Jean-Marc VERBRUGGHE, Alfortville (FR); Gaspard CELLIER, Alfortville (FR)

(73) Assignee: Minebea AccessSolutions France, Alfortville (FR)

(21) Appl. No.: 19/393,863

(22) Filed: Nov. 19, 2025

(30) Foreign Application Priority Data
Nov. 22, 2024 (EP) 24315531
Sep. 24, 2025 (EP) 25315335

(51) Int. Cl. E05B 81/06; E05B 81/18; E05B 81/30; E05B 81/36; E05B 81/66

(52) U.S. Cl. CPC E05B 81/06; E05B 81/18; E05B 81/30; E05B 81/36; E05B 81/66

(57) ABSTRACT

A vehicle door latch includes an engagement mechanism for engaging with a striker, an electric release mechanism including an electric release motor and being arranged for actuating the engagement mechanism from a closed position wherein the striker is retained by the engagement mechanism and an open position wherein the striker is released. The vehicle door latch includes an additional electric release mechanism acting in parallel to the electric release mechanism and including an additional electric release motor. The additional electric release mechanism displaces an element of the electric release mechanism or of the engagement mechanism to provide an additional force to actuate the engagement mechanism towards its open position.

### TECHNICAL FIELD

The present invention relates to the field of vehicle door latches to ensure the closing of vehicle doors and in particular to latches comprising an electric release mechanism.

### BACKGROUND OF THE INVENTION

The present invention refers to a vehicle door latch equipment comprising an electric release mechanism also called E-release mechanism.

Such an electric release mechanism has to open the door in a whole range of conditions that will be faced during the lifetime of the vehicle.

In particular, the vehicle may cope with low temperatures that may harden the seal arranged at the periphery of the door so that a force high enough is then necessary to open the door.

Thus, the electric release mechanism needs to provide a fast opening while having a sufficient force to open the door in all conditions to ensure the comfort of the users (no need to wait for the opening of the door nor to have to help the electric mechanism to open the door).

It is therefore a goal of the present invention to provide a vehicle door latch equipment with an electric release mechanism capable of opening the door in a short duration and also capable of applying a force high enough to open the door in all conditions.

### SUMMARY OF THE INVENTION

The present invention refers to a vehicle door latch comprising:
an engagement mechanism configured for engaging with a striker,
an electric release mechanism comprising an electric release motor and being configured for actuating the engagement mechanism from a closed position wherein the striker is retained by the engagement mechanism and an open position wherein the striker is released,
wherein the vehicle door latch comprises an additional electric release mechanism acting in parallel to the electric release mechanism and comprising an additional electric release motor, the additional electric release mechanism being configured to displace an element of the electric release mechanism or of the engagement mechanism to provide an additional force to actuate the engagement mechanism towards its open position.

The use of an additional electric release mechanism enables providing a force or torque high enough to open the vehicle door latch and release the striker in difficult conditions without disrupting of the vehicle door latch in normal conditions.

According to an embodiment of the present invention, the electric release mechanism comprises a worm arranged of an output shaft of the electric release motor and a gear wheel configured to mesh with the worm, the rotation of the gear wheel leading to the rotation of a driver of the engagement mechanism towards a release position which drives the rotation of a pawl towards a release position associated with the open position of the engagement mechanism.

According to another embodiment of the present invention, the additional electric release mechanism comprises an additional worm arranged on an output shaft of the additional electric release motor and an additional gear wheel configured to mesh with the additional worm and to displace a slidable lever configured to push on an element of the electric release mechanism or of the engagement mechanism.

According to another embodiment of the present invention, the engagement mechanism also comprises an intermediate rotatable lever configured to rotate between a rest position and an active position wherein it drives the rotation of the driver towards its release position, the intermediate rotatable lever being driven in rotation by a mechanical release mechanism or by the gear wheel of the electric release mechanism and wherein the slidable lever of the additional electric release mechanism is configured to push on the said intermediate rotatable lever.

According to another embodiment of the present invention, the electric release mechanism is configured to actuate the engagement mechanism towards its open position at a first speed and the additional electric release mechanism is configured to actuate the engagement mechanism towards its open position at a second speed lower than the first speed.

According to another embodiment of the present invention, the additional force applied by the additional electric release mechanism to actuate the engagement mechanism is higher than the force applied by the electric release mechanism to actuate the engagement mechanism.

According to another embodiment of the present invention, the additional electric release motor is configured to be actuated when the electric release motor is actuated.

According to another embodiment of the present invention, the additional electric release motor is configured to be actuated when a fault is detected in the electric release mechanism.

According to another embodiment of the present invention, the engagement mechanism comprises:
a claw configured to rotate between a closed position wherein the claw retains the striker and a release position wherein the striker is released to open the door and,
a sensor associated with the claw and configured to switch from a first state to a second state when the claw is in a release position,
   wherein a fault is detected if the switch remains in the first state after a predetermined duration after the activation of the electric release motor.

The present invention also refers to a vehicle door comprising a vehicle door latch as described previously.

The present invention also refers to a method for controlling a vehicle door latch as described previously wherein the method comprises the following steps:
a step of activating both the electric release motor and the additional electric release motor to open the vehicle door latch,
a step of driving the electric release motor and the additional electric release motor in opposite direction to reset the electric release mechanism and the additional electric release mechanism in their rest position after the opening of the vehicle door latch.

According to another embodiment of the present invention, the method comprises the following steps:
a step of activating the electric release motor to open the vehicle door latch,
a step of detecting an opening of the vehicle door latch or a fault in the electric release mechanism,
a step of driving the electric release motor in opposite direction to reset the electric release mechanism in its rest position if an opening of the vehicle door latch is detected,
a step of activating the additional electric release motor to open the vehicle door latch if a fault is detected in the electric release mechanism,
a step of driving the electric release motor and the additional electric release motor in opposite direction to reset the electric release mechanism and the additional electric release mechanism in their rest position after the opening of the vehicle door latch when a fault has been detected in the electric release mechanism.

According to another embodiment of the present invention, the step of activating the electric release motor to open the vehicle door latch comprises a sub-step of launching a timer of a predetermined duration and the step of detecting a fault in the electric release mechanism comprises a detection that the timer has lapsed.

### BRIEF DESCRIPTION OF THE DRAWINGS

FIG. 1 is a diagram of an inner side of a vehicle door;

FIG. 2 is a diagram of an embodiment of a vehicle door latch;

FIG. 3 is a perspective view of the electric release mechanism and the additional electric release mechanism according to an embodiment of the present invention;

FIG. 4a is a side view of elements of the vehicle door latch in a first state;

FIG. 4b is a side view of elements of the vehicle door latch in a second state;

FIG. 5a is a side view of elements of the vehicle door latch in a third state;

FIG. 5b is a side view of elements of the vehicle door latch in a fourth state;

FIG. 6 is a flowchart of the steps of a first embodiment of a method to control the vehicle door latch;

FIG. 7 is a chronograph of respectively the power of the electric release motor, the power of the additional electric release motor and the position of the pawl according to the first embodiment of the method to control the vehicle door latch;

FIG. 8 is a flowchart of the steps of a second embodiment of a method to control the vehicle door latch;

FIG. 9 is a chronograph of respectively the power of the electric release motor, the power of the additional electric release motor and the position of the pawl according to the second embodiment of the method to control the vehicle door latch in normal conditions;

FIG. 10 is a chronograph of respectively the power of the electric release motor, the power of the additional electric release motor and the position of the pawl according to the second embodiment of the method to control the vehicle door latch in abnormal conditions.

### DETAILED DESCRIPTION OF THE INVENTION

The following achievements are examples. Although, the specification refers to one or several embodiments, it does not imply that each reference refers to the same embodiment or that the features apply only to a single embodiment. Simple features of different embodiments can also be combined to provide other embodiments without departing from the scope of the invention given by the claims.

The present invention refers to a vehicle door latch 1 configured to ensure the closing of a vehicle door, in particular a side door or a trunk lid.

FIG. 1 is a diagram of an inner side of a vehicle door 100. The vehicle door 100 comprises a vehicle door latch 1 linked to an inner handle 3. The inner handle 3 may be linked to the vehicle door latch 1 via a Bowden cable 5 to provide a mechanical release of the vehicle door latch 1. The vehicle door latch 1 may also be linked to an outer handle (not represented).

In the present invention, the vehicle door latch comprises an electric release mechanism 17, the mechanical release being a back-up solution in case of a failure or a misfunctioning of the electric release mechanism 17.

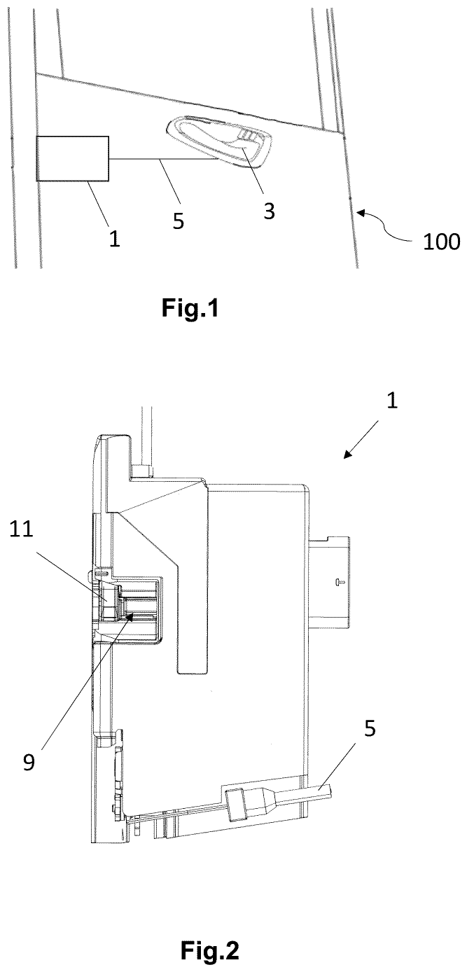

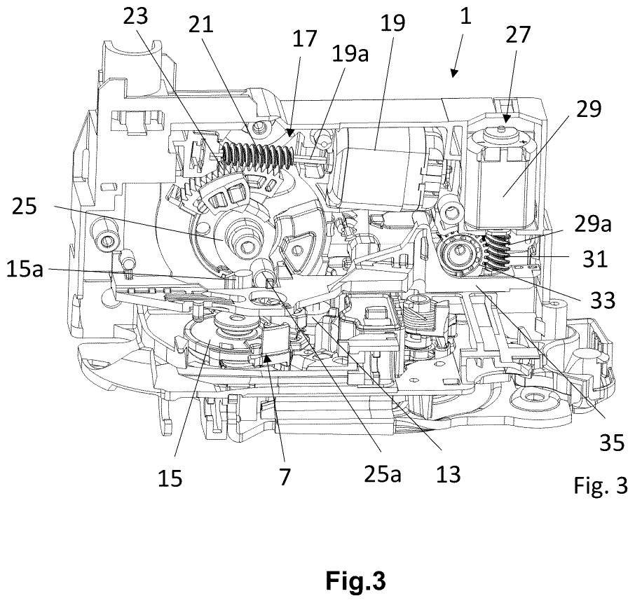

FIG. 2 represents an outside view of a vehicle door latch 1 and FIG. 3 represents parts of the elements of a vehicle door latch 1 according to the present invention.

### Engagement Mechanism 7

The vehicle door latch 1 comprises an engagement mechanism 7 configured for engaging with a striker (not represented). The striker is arranged on the vehicle body next to the vehicle door 100 and is configured to be introduced into a recess 9 of the vehicle door latch 1 when the vehicle door is closed. The engagement mechanism 7 comprises a claw 11 arranged at least partially in the recess 9 and configured to move between:
a closed position wherein the striker is retained within the recess 9 by the claw 11 and,
an open position wherein the striker may be disengaged from the vehicle door latch 1.
   The engagement mechanism 7 also comprises a pawl 13 configured to rotate between:
a blocking position wherein the pawl 13 blocks the rotation of the claw 11 so that the striker is retained by the claw 11 and,
a release position wherein the pawl 13 enables the rotation of the claw 11 and therefore the release of the striker to open the vehicle door 100.

The engagement mechanism 7 also comprises a driver 15 configured to engage with the pawl 13 to displace the pawl 13 towards its release position. The engagement mechanism 7 may also comprise a first elastic element such as a spring (not represented) configured to constrain the claw 11 in its open position and a second elastic element such as a spring configured to constrain the pawl 13 in its blocking position.

### Electric Release Mechanism 17

The vehicle door latch 1 also comprises an electric release mechanism 17. The vehicle door latch 1 may comprise an electric release mechanism 17 combined with a mechanical release mechanism (not represented) configured to be linked to the inner handle 3 and/or to the outer handle or only an electric release mechanism 17.

The electric release mechanism 17 comprises an electric release motor 19 with an output shaft 19a as represented in FIG. 2. A worm 21 is arranged on the output shaft 19a of the electric release motor 15 and is configured to mesh with a gear wheel 23. The gear wheel 23 is configured to engage directly or indirectly with the driver 15 in order to actuate the engagement mechanism 3. In the present example, the gear wheel 23 is configured to rotate an intermediate lever 25 which is configured to rotate the driver 15 so that the engagement mechanism 7 is brought in a release position. The intermediate lever 15 may be linked to the inner handle 3 via the Bowden cable 5 to provide a mechanical release of the vehicle door latch 1.

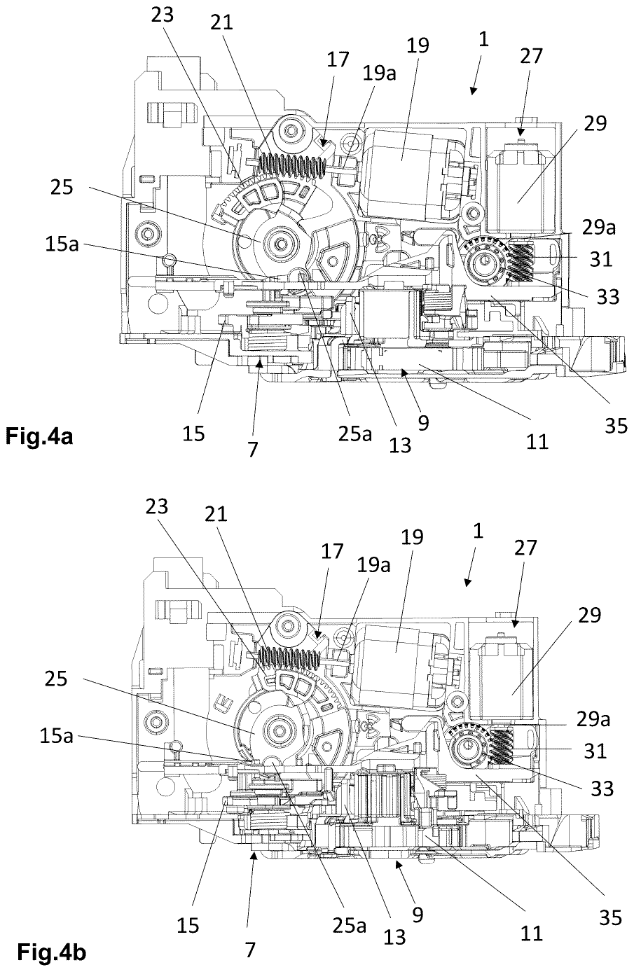

Thus, the rotation of the electric release motor 19 from the rest position of the electric release mechanism 17 represented in FIG. 4a towards the active position of the electric release mechanism 17 represented in FIG. 4b leads to the rotation of the gear wheel 23 via the worm 21. The rotation of the gear wheel 23 leads to the rotation of the intermediate lever 25 and consequently the rotation of the driver 15 via the pin 25a of the intermediate lever 25 pushing on the protrusion 15a of the driver 15. The rotation of the driver 15 leads to the displacement of the pawl 13 in its release position which allows the rotation of the claw 11 in its open position and therefore to the release of the striker. Other configurations of the electric release mechanism 17 are also possible.

### Additional Electric Release Mechanism 27

The vehicle door latch equipment 1 also comprises an additional electric release mechanism 27 configured to work in parallel to the electric release mechanism 17 to provide an additional force or torque to the engagement mechanism 7. Such additional torque/force may be necessary to open the vehicle door 100 for example in case of a frozen door seal. Thus, the electric release mechanism 17 and the additional electric release mechanism 27 may be activated separately or together (the additional electric release mechanism 27 may be used as a back-up in case of a failure of the electric release motor 19 for example).

The additional electric release mechanism 27 comprises an additional electric release motor 29 with an output shaft 29a. An additional worm 31 is arranged on the output shaft 29a.

The additional electric release mechanism 27 also comprises an additional gear wheel 33 configured to mesh with the additional worm 31.

The additional electric release mechanism 27 also comprises a slidable lever 35 configured to be displaced by the additional gear wheel 33. The slidable lever 35 comprises for example a rack configured to mesh with the pinion of the additional gear wheel 33. Alternatively, the slidable lever 35 may comprise a stop configured to be in contact with the additional gear wheel 33 so that the rotation of the additional gear wheel 33 drives the displacement of the slidable lever 35.

When displaced by the additional gear wheel 33, the slidable lever 35 is configured to interact with the intermediate lever 25 to drive the rotation of the driver 15. A protrusion 35a of the slidable lever 35 may be configured to come into contact with the pin 25a so that the displacement of the slidable lever 35 drives the rotation of the intermediate lever 25 and consequently the rotation of the driver 15 to displace the pawl 13 in a release position. Alternatively, the slidable lever 35 may be configured to come into contact and push the driver 15 directly or any other part of the engagement mechanism 7 or of the electric release mechanism 17 which may lead to the actuation of the engagement mechanism 7 in an open position (to release the striker and open the door).

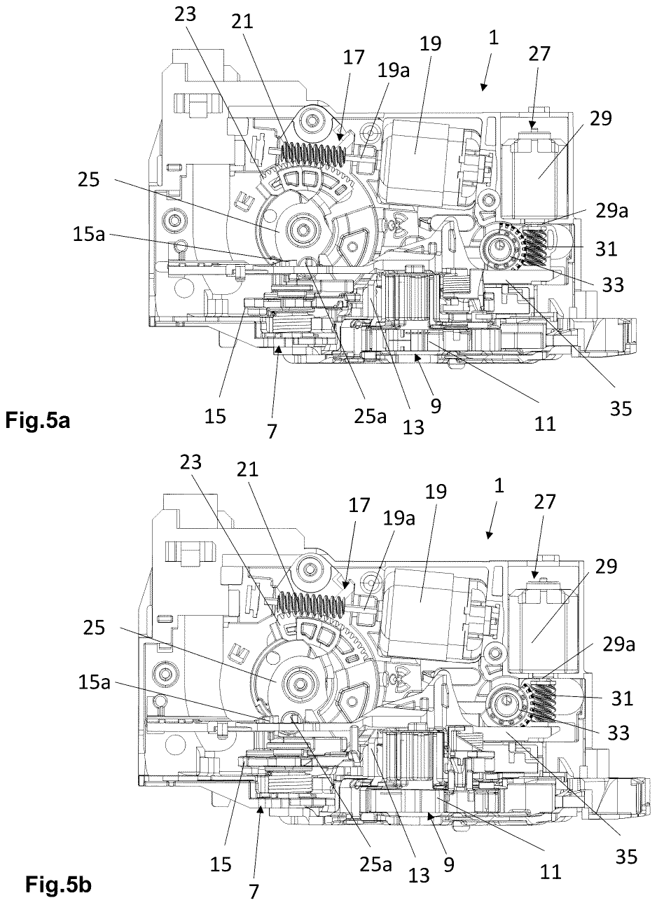

As a consequence, an activation of the additional electric release motor 29 from a rest position of the additional electric release mechanism 27 represented in FIG. 5a towards the active position of the additional electric release mechanism 27 represented in FIG. 5b drives the rotation of the additional gear wheel 33 via the worm 31 which leads to the displacement of the slidable lever 35 towards the pin 25a of the intermediate lever 25. The intermediate lever 25 is therefore displaced by the slidable lever 35 and drives the rotation of the driver 15 which leads to the displacement of the pawl 13 towards its release position and therefore to the rotation of the claw 11 in its open position which releases the striker and opens the vehicle door 100. The vehicle door 100 can therefore be opened by the additional release mechanism 27.

It has to be noted that in FIG. 5a, the electric release mechanism 17 is in an intermediate position between the rest position and the active position enabling the opening of the vehicle door latch 1. This intermediate position may correspond to a position wherein the electric release motor 19 is not capable of overcoming the resistant force applied by the door 100, for example due to a frozen seal.

Furthermore, the intermediate lever 25 may be displaced by the slidable lever 35 without displacing the gear wheel 23 so that the activation of the additional electric release motor 29 does not produce any constraints on the electric release motor 19.

Similarly, the intermediate lever 25 may be displaced by the gear wheel 23 without displacing the slidable lever 35 so that the activation of the electric release motor 19 does not produce any constraints on the additional electric release motor 29.

The electric release mechanism 19 and the additional electric release mechanism 29 may therefore act independently. They may also act together to produce a higher overall force on the driver 15 to release the vehicle door latch 1, for example in case of a frozen seal. In the example of FIG. 5b, both the electric release mechanism 19 and the additional electric release mechanism 29 are in an active position.

The size of the different gears (diameter of the gear wheel 23 and the additional gear wheel 33 and the thread of the worm 21 and the additional worm 31) may be chosen so that the electric release mechanism 17 is configured to drive the rotation of the driver 15 (and therefore the actuation of the engagement mechanism 7 in an open position) at a first speed while the additional electric release mechanism 27 is configured to drive the rotation of the driver 15 (and therefore the actuation of the engagement mechanism 7 in an open position) at a second speed lower than the first speed. The additional electric mechanism 27 may therefore drive the engagement mechanism 7 in an open position at a lower speed but may produce a higher force or higher torque on the engagement mechanism 7. Alternatively or in combination, the electric release motor 19 and the additional electric release motor 29 may be chosen so that the electric release motor 19 has a higher rotational speed than the additional electric release motor 29 and so that the additional electric release motor 29 provides a higher torque than the electric release motor 19.

With such configuration, the electric release mechanism 17 enables a fast opening of the vehicle door latch 1 in normal conditions due to the high speed of the electric release mechanism 17 to displace the driver 15 and the additional electric release mechanism 27 enables an opening in severe or abnormal conditions due to the additional force/torque provided to the driver 15. Even if the opening of the vehicle door latch 1 is slower than in normal conditions, the vehicle door latch 1 may be opened without the assistance of the user so that the comfort of the user is improved without requiring an oversized electric release motor 19.

Furthermore, such configuration of the additional electric release mechanism 27 is compact and limits therefore the bulk of the vehicle door latch 1.

### Control of the Electric Release Motor 19 and the Additional Electric Release Motor 29

According to a particular embodiment, the additional electric release motor 29 is configured to be activated when the electric release motor 19 is activated, for example upon reception of an opening request signal received by a control unit. The control unit may be a central control unit of the vehicle and the opening request signal may be received after a user has pushed on a button or has pulled on a handle to open the door 100. Both the electric release motor 19 and the additional electric release motor 29 are activated at the same time, for example by the control unit. However, in normal conditions, as the electric release motor 19 is configured to displace the driver 15 faster than the additional electric release motor 29, the driver 15 is driven in rotation by the sole electric release motor 19. Due to its configuration, the additional electric release mechanism 27 does not disturb the driving of the driver 15 by the electric release motor 19 (the slidable lever 35 does not touch the pin 25a of the intermediate lever 25 which is driven (away from slidable lever 35) by the electric release motor 19).

If the torque/force provided by the electric release motor 19 is sufficient to open the vehicle door latch 1, then the vehicle door latch 1 is opened by the sole electric release motor 19 even if the additional electric release motor 29 is also activated. After opening of the vehicle door latch 1, both the electric release motor 15 and the additional electric release motor 25 are deactivated. Before their deactivation, the electric release motor 19 and the additional electric release motor 29 may be reset to bring the electric release mechanism 17 and the additional electric release mechanism 27 back in their rest position represented in FIG. 4a. Such reset may be achieved by driving the electric release motor 19 and the additional electric release motor 29 in the opposite direction of rotation (with respect to the direction leading to the opening of the vehicle door latch 1).

If the torque provided by the electric release motor 19 is not sufficient to open the vehicle door latch 1, for example due to a frozen door seal. After a short time lapse, the additional electric release motor 29 has displaced the slidable lever 35 enough for the slidable lever 35 to come into contact with the pin 25a of the intermediate lever 25 which is blocked in an intermediate position which does not enable the engagement mechanism 7 to release the striker. The additional electric release motor 29 provides then, via the push of the slidable lever 35 on the pin 25a, an additional force/torque to the driver 15 via the pin 25a which enables the opening of the vehicle door latch 1 which releases the striker and opens the door 100. After the opening of the vehicle door latch 1, both the electric release motor 19 and the additional electric release motor 29 are deactivated or reset to bring the electric release mechanism 17 and the additional electric release mechanism 27 back in their rest position represented in FIG. 4a. Such reset may be achieved by driving the electric release motor 19 and the additional electric release motor 29 in the opposite direction of rotation (with respect to the direction leading to the opening of the vehicle door latch 1).

Thus, in this particular embodiment, both the electric release motor 19 and the additional electric release motor 29 are activated from the beginning of the opening process but in most cases, only the electric release motor 19 is useful to open the vehicle door latch 1.

According to another embodiment, only the electric release motor 19 is activated when a release request signal is received. The activation of the electric release motor 19 may be achieved by the control unit upon reception of an opening request signal for example further to the push or pull of a user on a button or a handle to open the door. The additional electric release motor 29 is configured to be activated only when a fault is detected in the electric release mechanism 17. The fault may correspond to a blocking of the electric release motor 19 due to a resistant force of the vehicle door 100, for example because of a frozen seal. The control unit may be configured to launch a timer of a predetermined duration when the electric release motor 19 is activated and the electric release mechanism 17 may be considered as faulty if the vehicle door latch 1 is not in an open position after the predetermined duration. Thus, when the timer has lapsed, the electric release mechanism 17 is considered as faulty and the additional release motor 29 is activated. A sensor may be arranged next to the claw 11 to detect an open position of the vehicle door latch 1.

In any case, when a fault of the electric release mechanism 17 is detected, the additional electric release motor 29 is activated to provide an additional torque/force to the driver 15 to open the vehicle door latch 1. With this embodiment, the time required to open the door in abnormal conditions (frozen seal, etc . . . ) is higher (than with the previous embodiment wherein both motors are activated at the same time) but the energy consumption is reduced due to the fact that the additional electric release motor 29 is activated only when it is required.

Thus, the use of an electric release motor 19 and an additional electric release motor 29 enables a fast opening of the vehicle door latch 1 and therefore of the vehicle door in normal conditions and a slower opening of the vehicle door latch 1 in severe conditions so that the door may be opened in most conditions without requiring the help of the user. Furthermore, the additional electric release motor 29 may have a low consumption due to the additional electric release mechanism 27 that enables to obtain a high torque/force thanks to the size of the gears (diameter, number of teeth and thread). The consumption may be further reduced if the additional electric release motor 29 is activated only if required (which would lead to an opening of a longer duration in severe conditions). Furthermore, due to the compact size of the additional electric release mechanism 27, such feature barely increases the bulk of the vehicle door latch 1.

The present invention refers also to a vehicle door 100 comprising a vehicle door latch 1 as disclosed above.

### Method for Controlling the Vehicle Door Latch 1

The present invention also refers to a method for controlling a vehicle door latch 1 as described previously.

### First Embodiment

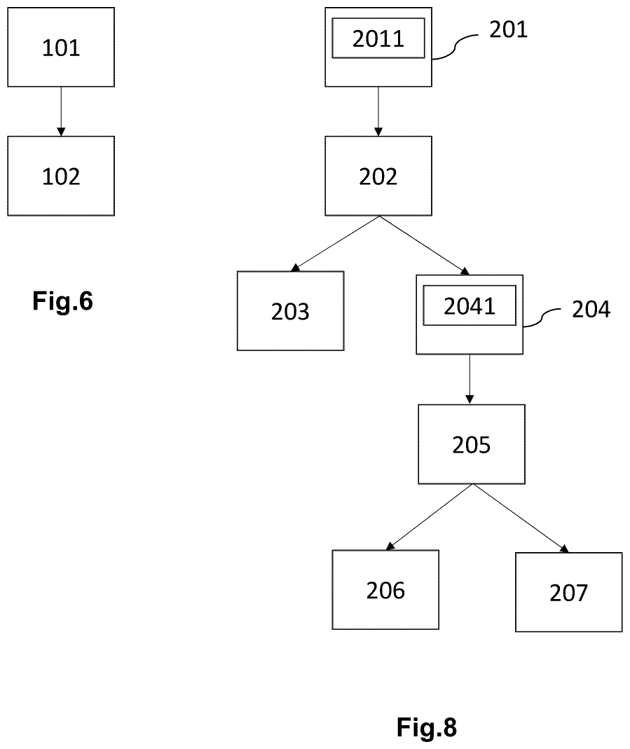

According to a first embodiment represented in FIG. 6, the method comprises the following steps.

A first step 101 wherein upon reception of an opening request signal, the electric release motor 19 and the additional electric release motor 29 are both activated to open the vehicle door latch 1. Either, the torque produced by the electric release motor 19 is sufficient and the vehicle door latch 1 is opened due to the sole action of the electric release motor 19 (the additional electric release motor 29 is activated but does not contribute to the opening of the vehicle door latch 1) or the torque of both the electric release motor 19 and the additional electric release motor 29 is necessary and the vehicle door latch 1 is opened by the contribution of both the electric release motor 19 and the additional electric release motor 29.

The second step 102 refers to the driving of the electric release motor 19 and the additional electric release motor 29 in opposite direction to reset the electric release mechanism 17 and the additional electric release mechanism 27 in their rest position after the opening of the vehicle door latch 1. The opening status of the vehicle door latch 1 may be transmitted by a sensor configured to detect an open position of the claw 11 in order to reset the electric release mechanism 17 and the additional electric release mechanism 27 only when the vehicle door latch 1 has been opened.

Some of the steps may be optional and the order of the steps may be different than the presented order.

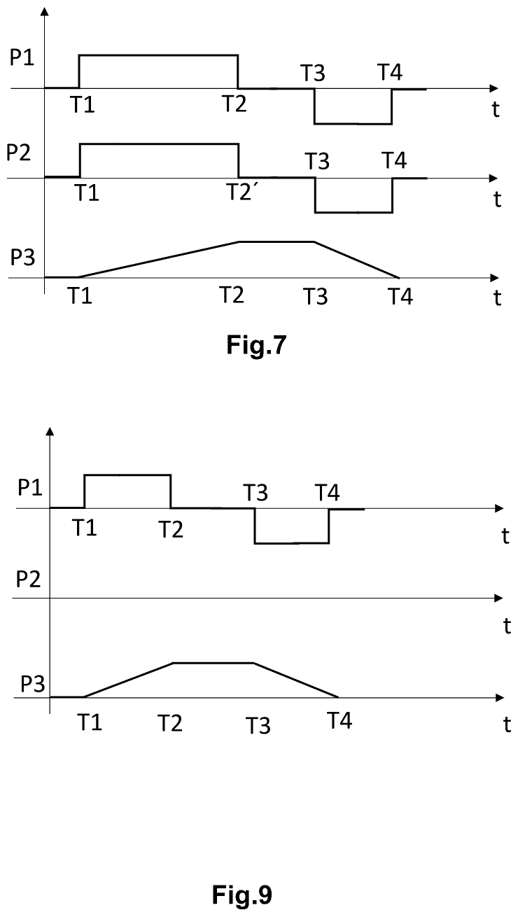

FIG. 7 represents a chronograph of respectively the power P1 provided by the electric release motor 19, the power P2 provided by the additional electric release motor 29 and the position p3 of the pawl 13 for this first embodiment. The step 101 occurs at time T1 so that both the electric release motor 19 and the additional electric release motor 29 are activated to open the vehicle door latch 1. At time T2, the electric release motor 19 has displaced the electric release mechanism 17 in active state so that the pawl 13 is in a release state at time T2. At time T2′ which may be the same time as T2, the additional electric release motor 29 has brought the additional electric release mechanism 27 in an active position. The time T2′ may be later than the time T2 as the additional electric release mechanism 27 is slower than the electric release mechanism 17. At time T3, which may be right after T2 or T2′ and the opening of the vehicle door latch 1, the step 102 occurs so that the electric release motor 19 and the additional electric release motor 29 are reset (the negative power indicates that they rotate in an opposite direction) to bring the electric release mechanism 17 and the additional electric release mechanism 27 back in their rest position at time T4. The pawl 13 is also brought back to its blocking position at the time T4.

### Second Embodiment

According to a second embodiment represented in FIG. 8, the method comprises the following steps.

A first step 201 wherein upon reception of an opening request signal, the electric release motor 19 is activated to open the vehicle door latch 1. The step 201 may also comprise a sub step 2011 associated with the launching of a first timer of a first predetermined duration. The first predetermined duration corresponds to a duration longer than the duration necessary for the electric release motor 19 to open the vehicle door latch 1 (in normal conditions).

A second step 202 of detecting an opening of the vehicle door latch 1 or a fault in the electric release mechanism 17. The opening status of the vehicle door latch 1 may be transmitted by a sensor configured to detect an open position of the claw 11. A fault may be detected if the first timer has lapsed.

If an opening of the vehicle door latch is detected, the method goes to step 203 and if a fault in the electric release mechanism 17 is detected, the method goes to step 204.

The third step 203 refers to the driving the electric release motor 19 in opposite direction to reset the electric release mechanism 17 in its rest position.

The fourth step 204 refers to the activation of the additional electric release motor 29 to open the vehicle door latch 1 (in addition to the electric release motor 19). The fourth step 204 may also comprise a sub step 2041 associated with the launching of a second timer of a second predetermined duration. The second predetermined duration corresponds to a duration longer than the duration necessary for the additional electric release motor 29 to open the vehicle door latch 1.

The fifth step 205 refers to the detection of an opening of the vehicle door latch 1 or a fault in the additional electric release mechanism 17.

If an opening of the vehicle door latch 1 is detected, the method goes to step 206 and if a fault in the additional electric release mechanism 17 is detected, for example if the second timer has lapsed while the vehicle door latch 1 is not opened, the method goes to step 207.

The sixth step 206 refers to the driving of the electric release motor 19 and the additional electric release motor 29 in opposite direction (with respect to the direction used to open the vehicle door latch 1) to reset the electric release mechanism 17 and the additional electric release mechanism 27 in their rest position after the opening of the vehicle door latch (1) when a fault has been detected in the electric release mechanism (17).

The seventh step 207 refers to the emission of an alert signal indicating that an electric release of the door is not possible.

Some of the steps may be optional and the order of the steps may be different than the presented order.

FIG. 9 represents a chronograph of respectively the power P1 provided by the electric release motor 19, the power P2 provided by the additional electric release motor 29 and the position p3 of the pawl 13 for this second embodiment is normal conditions. The step 201 occurs at time T1 so that the electric release motor 19 is activated (the additional electric release motor 29 remains deactivated) to open the vehicle door latch 1. The first timer is also launched at time T1. At time T2, the electric release motor 19 has displaced the electric release mechanism 17 in its active state (before the timer T1 has lapsed) so that the pawl 13 is in a release position at time T2. At time T3, which may be right after T2 and the opening of the vehicle door latch 1, the step 203 occurs so that the electric release motor 19 is reset (the negative power indicates that it rotates in an opposite direction) to bring the electric release mechanism 17 back in its rest position at time T4. The pawl 13 is also brought back to its blocking position at the time T4.

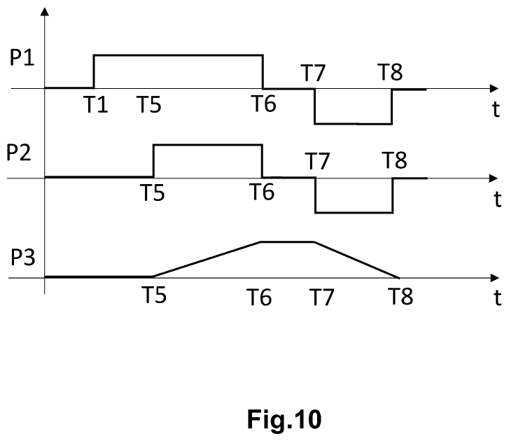

FIG. 10 represents a chronograph of respectively the power P1 provided by the electric release motor 19, the power P2 provided by the additional electric release motor 29 and the position p3 of the pawl 13 for the second embodiment in abnormal conditions. The step 201 occurs at time T1 so the electric release motor 19 is activated to open the vehicle door latch 1 (the additional electric release motor 29 remains deactivated). The first timer is also launched at time T1. At time T5, the first timer has lapsed while the pawl 13 is not in its released position so that the step 204 occurs wherein the additional electric release motor 29 is activated to provide an additional force/torque to open the vehicle door latch 1. At time T6, both the electric release mechanism 17 and the additional electric release mechanism 27 have brought the pawl 13 in its release position. At time T7, which may be right after T6 and the opening of the vehicle door latch 1, the step 206 occurs so that the electric release motor 19 and the additional electric release motor 29 are reset (the negative power indicates that they rotate in an opposite direction) to bring the electric release mechanism 17 and the additional electric release mechanism 27 back in their rest position at time T8. The pawl 13 is also brought back to its blocking position at the time T8.

Thus, the vehicle door latch 1 may be controlled according to a first embodiment limiting the delay to open the vehicle door 100 or according to a second embodiment limiting the energy consumption of the vehicle door latch 1. The control unit may also be configured to control the vehicle door latch 1 according to the first embodiment in some conditions and according to the second embodiment in other conditions, for example according to the first embodiment if the external temperature is lower than 5° C. and according to the second embodiment if the external temperature is higher or equal to 5° C.

1-13. (canceled)

14. A vehicle door latch, comprising:
an engagement mechanism configured to engage with a striker;
an electric release mechanism comprising an electric release motor and being configured to actuate the engagement mechanism from a closed position wherein the striker is retained by the engagement mechanism and an open position wherein the striker is released; and
an additional electric release mechanism acting in parallel to the electric release mechanism and comprising an additional electric release motor, the additional electric release mechanism being configured to displace an element of the electric release mechanism or of the engagement mechanism to provide an additional force to actuate the engagement mechanism towards the open position.

15. The vehicle door latch in accordance with claim 14, wherein the electric release mechanism comprises a worm arranged of an output shaft of the electric release motor and a gear wheel configured to mesh with the worm, a rotation of the gear wheel leading to a rotation of a driver of the engagement mechanism towards a release position which drives a rotation of a pawl towards a release position associated with the open position of the engagement mechanism.

16. The vehicle door latch in accordance with claim 15, wherein the additional electric release mechanism comprises an additional worm arranged on an output shaft of the additional electric release motor and an additional gear wheel configured to mesh with the additional worm and to displace a slidable lever configured to push on an element of the electric release mechanism or of the engagement mechanism.

17. The vehicle door latch in accordance with claim 16, wherein the engagement mechanism further comprises an intermediate rotatable lever configured to rotate between a rest position and an active position wherein the intermediate rotatable lever drives the rotation of the driver towards the release position, the intermediate rotatable lever being driven in rotation by the gear wheel of the electric release mechanism and wherein the slidable lever of the additional electric release mechanism is configured to push on the intermediate rotatable lever.

18. The vehicle door latch in accordance with claim 14, wherein the electric release mechanism is configured to actuate the engagement mechanism towards the open position at a first speed and the additional electric release mechanism is configured to actuate the engagement mechanism towards the open position at a second speed lower than the first speed.

19. The vehicle door latch in accordance with claim 14, wherein the additional force applied by the additional electric release mechanism to actuate the engagement mechanism is higher than a force applied by the electric release mechanism to actuate the engagement mechanism.

20. The vehicle door latch in accordance with claim 14, wherein the additional electric release motor is configured to be actuated when the electric release motor is actuated.

21. The vehicle door latch in accordance with claim 14, wherein the additional electric release motor is configured to be actuated when a fault is detected in the electric release mechanism.

22. The vehicle door latch in accordance with claim 21, wherein the engagement mechanism comprises:
a claw configured to rotate between a closed position wherein the claw retains the striker and a release position wherein the striker is released to open the vehicle door and,
a sensor associated with the claw and configured to switch from a first state to a second state when the claw is in a release position,
wherein a fault is detected when the sensor remains in the first state after a predetermined duration after an activation of the electric release motor.

23. A vehicle door, comprising:
the vehicle door latch in accordance with claim 14.

24. A method for controlling the vehicle door latch in accordance with claim 14, wherein the method comprises the following steps:
activating both the electric release motor and the additional electric release motor to open the vehicle door latch; and
driving the electric release motor and the additional electric release motor in opposite directions to reset the electric release mechanism and the additional electric release mechanism in their rest position after the opening of the vehicle door latch.

25. A method for controlling the vehicle door latch in accordance with claim 14, wherein the method comprises the following steps:
activating the electric release motor to open the vehicle door latch;
detecting an opening of the vehicle door latch or a fault in the electric release mechanism;
driving the electric release motor in an opposite direction to reset the electric release mechanism in a rest position when an opening of the vehicle door latch is detected;
activating the additional electric release motor to open the vehicle door latch when a fault is detected in the electric release mechanism; and
driving the electric release motor and the additional electric release motor in opposite directions to reset the electric release mechanism and the additional electric release mechanism in their rest position after the opening of the vehicle door latch when a fault has been detected in the electric release mechanism.

26. The method in accordance with the claim 25, wherein
the activating the electric release motor to open the vehicle door latch comprises launching a timer of a predetermined duration, and
the detecting the fault in the electric release mechanism comprises detecting that the timer has lapsed.
